(19) United States
(12) Patent Application Publication
(10) Pub. No.: US 2013/0312909 A1
(43) Pub. Date: Nov. 28, 2013

(54) ERGONOMIC HAND TOOL AND METHOD OF USE

(71) Applicant: Lawrence J. Thurston, Fremont, OH (US)

(72) Inventor: Lawrence J. Thurston, Fremont, OH (US)

(73) Assignee: EVERHARD PRODUCTS, INC., Canton, OH (US)

(21) Appl. No.: 13/480,106

(22) Filed: May 24, 2012

(51) Int. Cl. B32B 37/10

(52) U.S. Cl. 156/306.3; 156/579

(57) ABSTRACT

A hand tool for press sealing roofing membranes by a roller mounted on one end of a bracket connected at a second hand to a handle. The handle and roller mounting bracket extend along first and second axes respectively, which axes form an included angle in the range of 50 degrees and 70 degrees. This angular relationship enables a user's wrist to be the natural wrist position when moving the roller along the membrane. The second axis of the roller mounting bracket preferably maintains an angle of between 20 degrees and 40 degrees with the roofing membranes as the roller is moved along the membrane.

### BACKGROUND OF THE INVENTION

1. Technical Field

The invention relates to a method and apparatus for joining roofing membranes preferably by press welding overlapping heated edges of the membrane sheets together to form a sealed seam by a roller having an ergonomic handle which properly positions the arm, wrist and hand of the installer in a natural relaxed working position and which supplies needed pressure by utilizing the power of the whole arm and reduces fatigue.

2. Background Information

Sheets of roofing membrane are commonly used in many industrial and commercial roofing applications wherein large sheets of a waterproof membrane, are overlapped and then heated and pressed together to form a heat weld. These sheets are usually an elastomeric-type of material such as various rubber compositions, or thermoplastic sheets and the like. When done properly this method forms a strong water impervious seam which prevents subsequent peeling apart of the seam and prevents the penetration of water. Various types of devices have been developed for initially heating the edges of the overlapped membrane sheets, such as power propelled roller mechanisms which move along the seam and applies pressure to the overlapped sheets with a following roller. These machines work well for long flat seams but cannot function around many protrusions present on a roof. Therefore, various hand manipulated rollers have been developed and used for applying the pressure against the overlapping membranes.

Some examples of prior art seam rollers are shown in U.S. Pat. Nos. 5,393,289; 6,875,162; and 7,588,523. Although these rollers perform satisfactory for their intended purpose, they result in the installer's forearm, wrist and hand not being in alignment or in the “natural wrist position,” but in an annular wrist position when moving the roller across the membrane. This results in a larger pushing or pulling force being required on the handle in order to get the desired force component which is exerted directly downwardly from the roller onto the membrane to join the overlapping seams. Most importantly, this results in excessive fatigue on the arm, hand and wrist of the installer after use of the hand tool over a long period of time, which usually occurs during a work day. Such an unnatural wrist position being applied by the installer to achieve the desired downward force component over extended days, months and years could ultimately result in physical problems to the installer.

Performing hand intensive tasks with a bent wrist, either up, down, or side-to-side creates considerable stress on the tendons and their sheathes as they are bent across the harder bones and ligaments that make up the outside structure of the wrist. Bending the wrist while performing repetitive actions pulls the tendons over the bone and ligaments in the wrist. The creates irritation to the tendon, and especially the tendon sheathes, which is caught between the tendon and bone or ligament. This action creates irritation, inflammation, and eventually tendonitis or tenosynovitis.

Keeping the wrist as straight as possible while performing a repetitive task, the tendons can slide easily through the sheath. Using appropriately designed hand tools such as the roller of the present invention, enables the wrist to remain straight and reduce possible physical damage to the user and considerably reduces fatigue during a normal work day.

Therefore, the need exists in the roofing industry to provide a hand tool and method of use which enables an installer to press together heated overlapped seams of membranes by moving a roller over the edge to form the seam by an ergonomic handle construction which properly positions the arm, wrist and hand in a natural relaxed working position while providing a sufficient effective downward force component against the membrane when applying pressure to the handle, and which utilizes the power of the forearm and subsequently conserves energy and less stress on the hand, wrist and arm of the installer.

### BRIEF SUMMARY OF THE INVENTION

One aspect of the present invention is to provide a hand operated tool which enables a roller rotatably mounted on one end of the handle, which when moved over overlapped heated membrane sheet edges, will pressure join the overlapping edges forming a waterproof seal. The tool includes a roller rotatably mounted on a shaft which is connected to a handle by an intervening roller mounting bracket, which handle is inclined with respect to the roller mounting bracket to form an included angle therebetween generally within the range of 50 degrees and 70 degrees.

This angular relationship between the handle and roller mounting bracket provides for the proper positioning of the installer's arm, wrist and hand in a more natural relaxed working position and which supplies the required downward working force component exerted by the roller on the membrane with less pressure applied to the handle, and most importantly without bending or flexing of the user's wrist as in heretofore used seam rollers.

A further feature of the present invention is to provide such a hand tool in which the handle thereof is a generally linearly extending member which extends along a first axis and the roller is attached to the handle by a mounting bracket which extends generally along a second axis, and in which the first and second axes form the desired included angle therebetween of 50 degrees and 70 degrees.

Still another aspect of the present invention is to form the mounting bracket as a one-piece metal bar having a first straight linear section which is embedded into the handle and is connected to a second generally linearly extending main section by a curved corner, which curved corner forms the desired angle of between 50 degrees and 70 degrees between the roller mounting bracket and handle. The main linear section of the mounting bracket is preferably connected to the roller shaft by a shorter offset linear section which extends generally parallel with the main linear section of the mounting bracket.

Another feature of the present invention is to form the handle as a one-piece molded plastic member which includes a linear handle section adapted to be grasped by the installer and a second linear smaller section joined to the handle linear section by a curved corner, wherein these first and second linear sections form the desired included angle of between 50 degrees and 70 degrees. This one-piece molded plastic handle is then connected to the roller shaft by a generally Z-shaped metal bar, one end of which is embedded into the shorter linear section of the handle and extends generally along the linear axis of the smaller linear section.

A further feature of the invention is to construct the hand tool so that an imaginary isosceles triangle is formed between the midpoint of a linearly extending handle, linearly extending roller mounting bracket, and the rotational center of the roller in order to provide the desired natural wrist position when using the hand tool for rolling along membranes or similar work tasks.

These objectives and advantages are obtained by the hand tool of the present invention, the general nature of which may be stated as comprising: a handle having front and back ends and a first axis extending therebetween; a roller mounting bracket extending from the front end of the handle and extending along a second axis; a shaft attached to a distal end of the mounting bracket; a roller rotatably mounted on the shaft; and wherein the first and second axes form an included angle generally in the range of 50 degrees to 70 degrees.

These objectives and features are further obtained by the method of the present invention, the general nature of which may be stated as including the steps of: providing a hand-held tool having a handle, a roller mounting bracket attached to and extending from the handle and a roller rotatably mounted on a distal end of the mounting bracket for moving along at least one of the sheets, said handle extending substantially along a first axis and said roller mounting bracket extending substantially along a second axis with said first and second axes forming an included angle of between 50 degrees and 70 degrees; and moving the roller along the at least one of the sheets of sealable material by manually applying either a pushing or pulling force on the handle while generally maintaining an angle of between 20 degrees and 40 degrees between the said one sheet and the second axis of the roller mounting bracket enabling the forearm and wrist of a user to be in linear alignment.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a right side elevational view of the hand tool of the present invention;

FIG. 2 is a front elevational view of the hand tool as shown in FIG. 1;

FIG. 3 is a rear elevational view of the hand tool as shown in FIG. 1;

FIG. 4 is a left side elevational view of the hand tool of FIG. 1;

FIG. 5 is a top plan view of the hand tool of FIG. 1;

FIG. 6 is a bottom view of the hand tool as shown in FIG. 1;

FIG. 7 is a sectional view taken on line 7-7, FIG. 2;

FIG. 8 is a diagrammatic perspective view showing the hand tool moving along a roofing membrane in a first operating position;

FIG. 9 is a diagrammatic perspective view showing the hand tool in a different operating position than that of FIG. 8;

FIG. 10 is a side elevational view with portions broken away and in section, of a second embodiment of the hand tool of the present invention; and

FIG. 11 is a bottom plan view of the hand tool of FIG. 10.

Similar numbers refer to similar parts throughout the drawings.

### DETAILED DESCRIPTION OF THE INVENTION

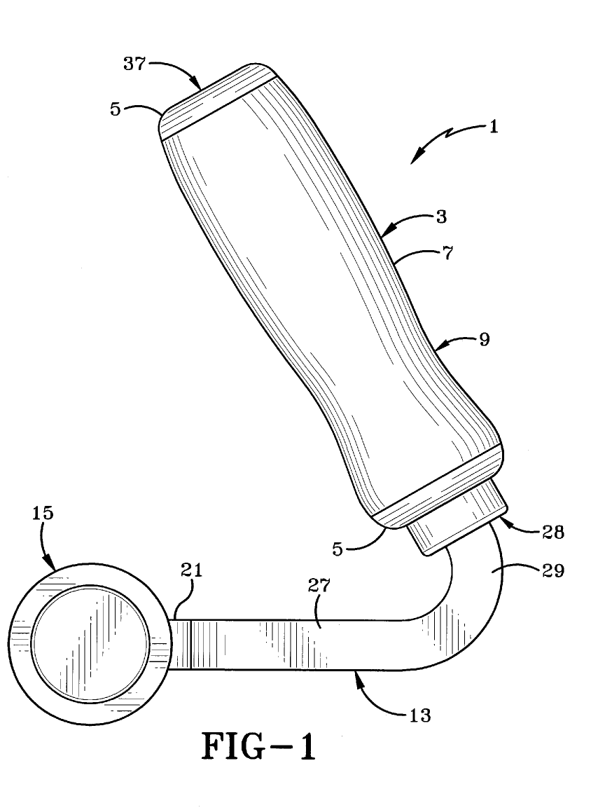

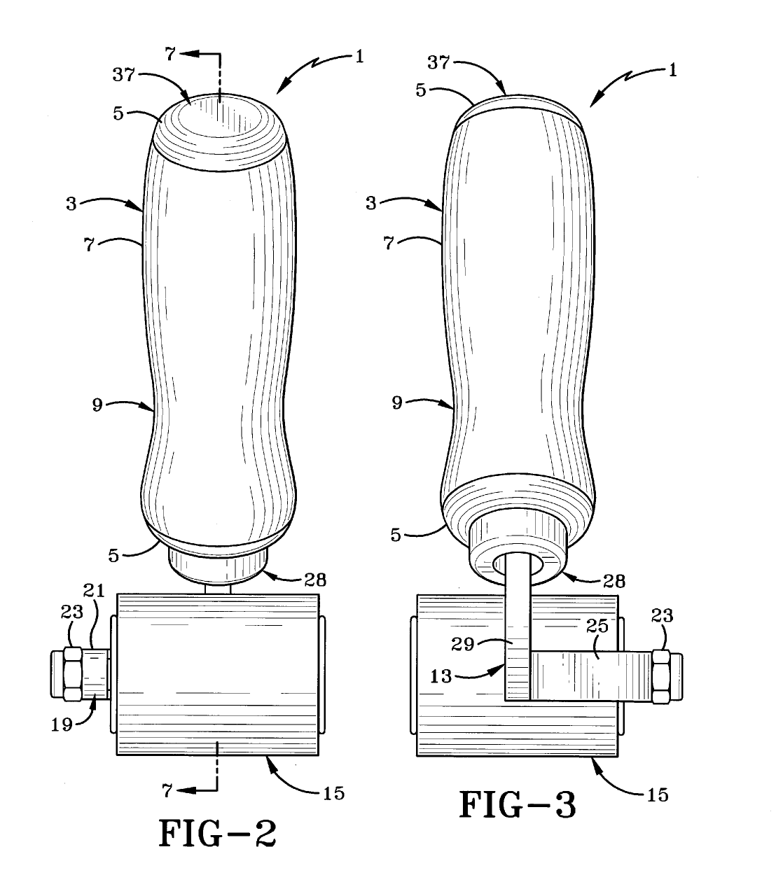

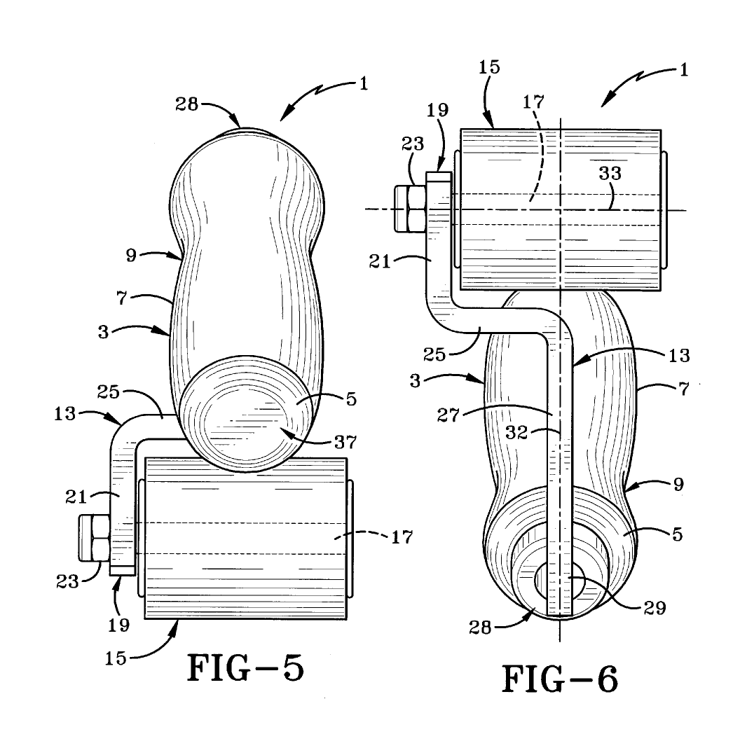

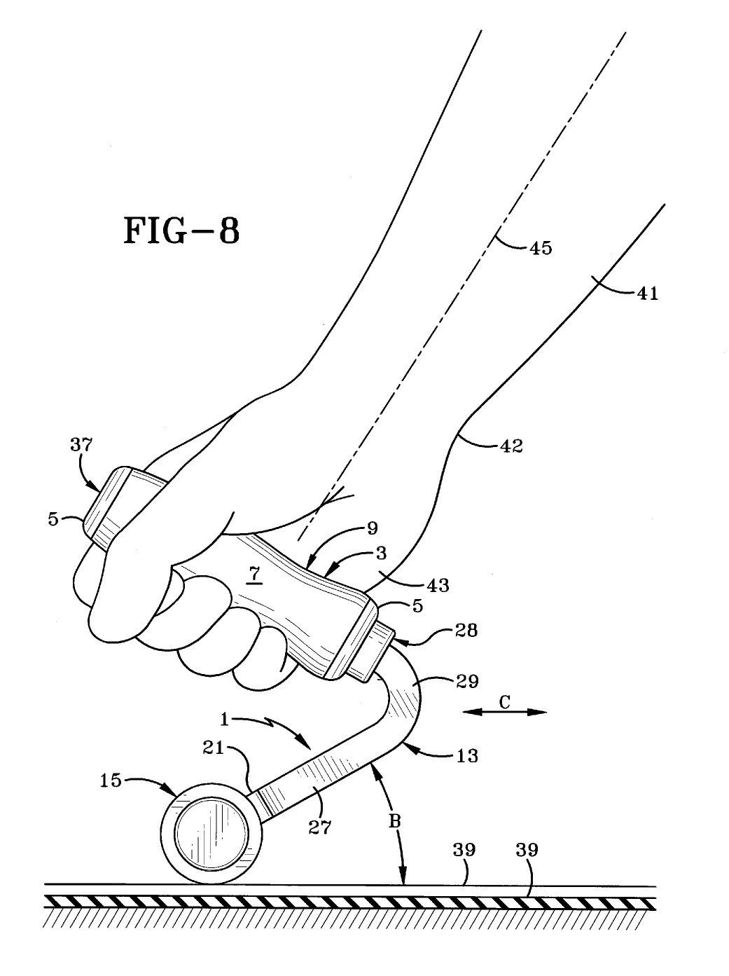

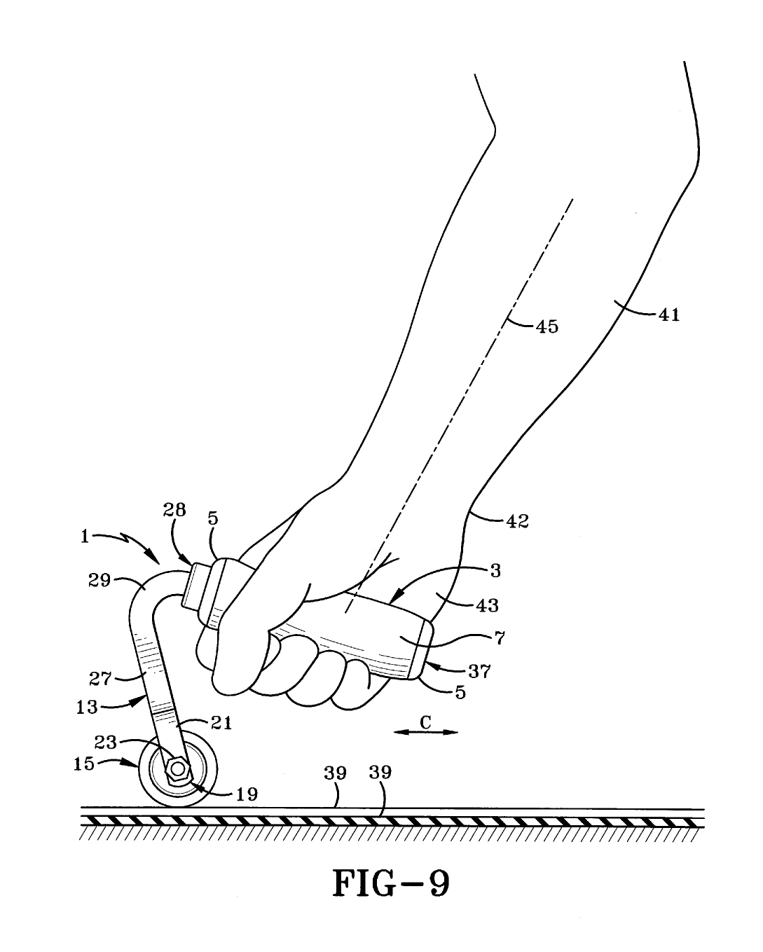

The improved hand tool of the present invention is indicated generally at 1 and is shown particularly in FIGS. 1-7. Hand tool 1 is shown in FIGS. 8 and 9 being moved along a membrane in two different working positions to form a joint seam.

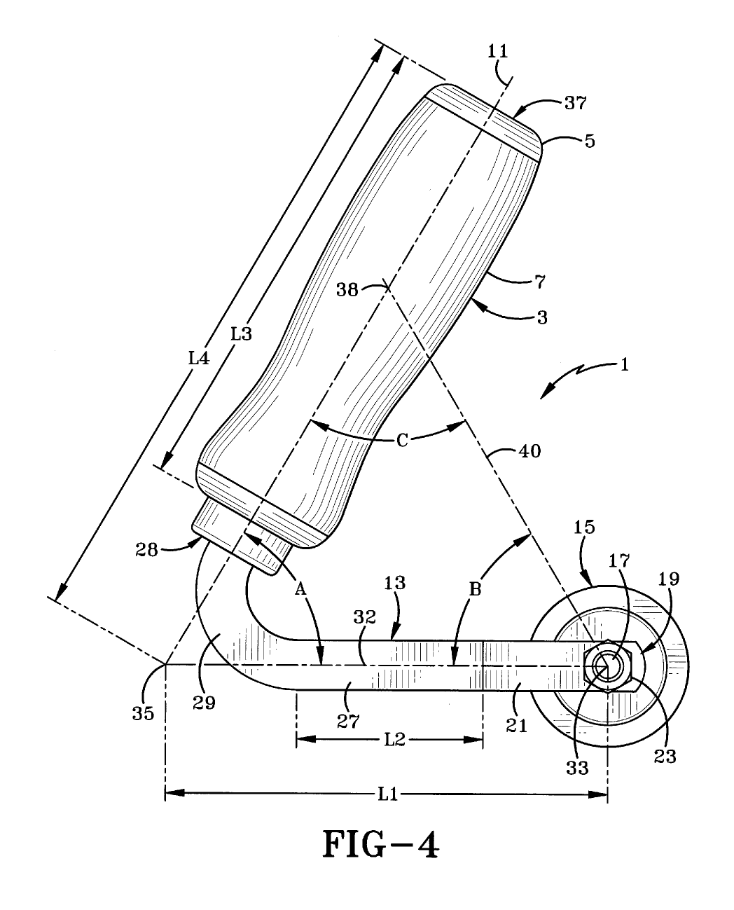

Tool 1 includes a rigid handle 3 which can be formed of various materials such as wood or metal and preferably has an outer cover 7 of a softer material than that of material 5. Handle 3 preferably has a slight concave region 9 to provide an ergonomic gripping configuration to the handle. Handle 3 preferably has a generally linear configuration with a longitudinal axis 11 (FIG. 4) which extends generally throughout the length of the handle.

A roller mounting bracket indicated generally at 13, extends between handle 3 and a seam roller 15. Roller 15 is rotatably mounted on a shaft 17 and extends in a cantilever fashion outwardly from an outer distal end 19 of a linearly extending bracket leg or section 21. Roller 15 usually is formed of an elastomeric, metal or plastic type material well-known in the roofing industry and is rotatably mounted on fixed shaft 17 by internal bearings (not shown), a construction well-known in the art. Shaft 17 is secured on distal end 19 of section 21 by a nut 23 or other type of attachments.

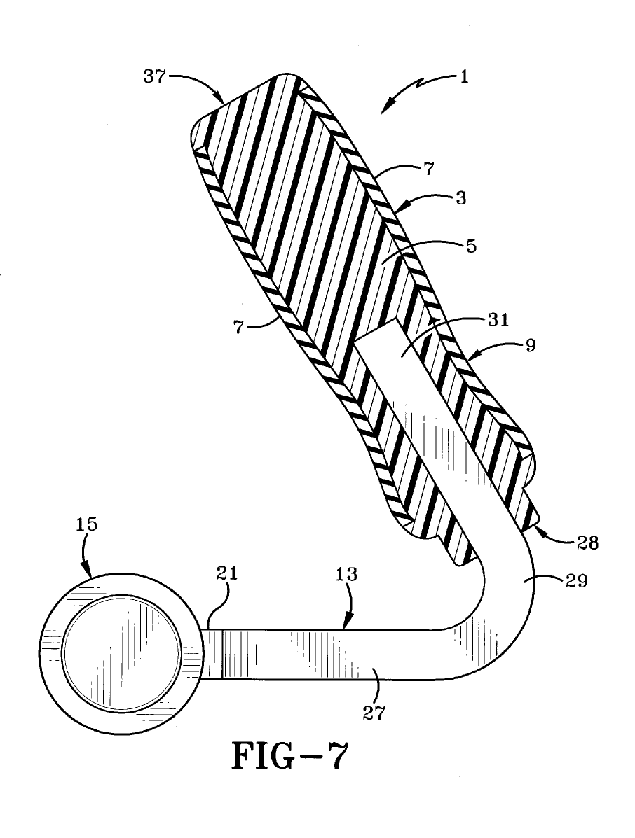

Roller mounting bracket 13 preferably is formed of a single piece of rigid metal, and in addition to linear section 21 includes another linear section or leg 25 (FIG. 6) which extends at a right angle to leg 21 and connects to a linearly extending elongated main bracket section or leg 27 also at a right angle to leg 25. Main linear section 27 merges into a rounded corner 29 (FIG. 7) and terminates in another linearly extending elongated section or bracket leg 31. Section 31 is attached to the front end 28 of handle 3, preferably by being embedded therein as shown in FIG. 7. Main linear section 27 extends along a second axis 32 (FIG. 4), and in accordance with one of the main features of the invention, merges with longitudinal axis 11 of handle 3 at an apex 35 to form an included angle A provided by curved corner 29.

In accordance with the invention, angle A is generally in the range of between 50 degrees and 70 degrees, with the preferred angle being approximately 60 degrees. The effective linear length of bracket 13 extending along main bracket leg 27 and offset leg 21 extending between the axis of rotation 33 of roller 15, indicated as length L1, to the junction or apex 35 of axes 11 and 32 is generally in the range of 3½ inches and 4½ inches, with the preferred length being approximately 4 7/16 inches. The preferred length of main bracket leg 27, indicated as L2, is between 1¾ inches and 2 inches. The linear length of handle 3 indicated in FIG. 4 as L3 is within the range of 4½ inches and 5½ inches with a preferred length of approximately 5 inches and the distance extending from the outer or back end 37 of handle 3 to apex 35 is in the range of 5¼ inches to 7¼ inches, with the preferred length being 6¼ inches and is indicated as L4. These dimensions are the preferred sizes which provide for the desired ergonomic effect of tool 1. However, these dimensions can vary, as well as that of angle A and still achieve the results of the ergonomic effect provided by handle tool 1.

Furthermore, as best shown in FIG. 6, the axis of rotation 33 of roller 15 is perpendicular to linear axis 32 of roller mounting bracket 13.

Another manner of describing the relationship between handle 3, bracket 13, and roller 15 is shown in FIG. 4 wherein axes 11 and 33 form an isosceles triangle with an imaginary line 40 extending from the axis of rotation 33 of roller 15 generally through the midpoint 38 of handle 3.

In accordance with the invention, hand tool 1 when in use, is moved in the direction of Arrow C, FIG. 8, in either a forward direction or rearward direction over one or a pair of roofing membranes 39 wherein roller mounting bracket 13 is at an angle B with respect to membranes 39. Angle B preferably is within the range of 20 degrees and 40 degrees with a preferred angle of approximately 30 degrees. Maintaining angle B within the preferred range of between 20 degrees and 40 degrees has been found to exert an efficient downward force component against membranes 39, and most importantly maintains the user's wrist 42 in the “natural wrist position.” As shown in FIGS. 4 and 8, the forming of handle 3 and bracket 13 at an angle A being within the desired range discussed above, enables the installer's arm 41, wrist 42 and hand 43 to be maintained in a general alignment shown by line 45, which enables the full power of the arm to be transmitted directly through the wrist and hand to the handle which subsequently exerts the desired downward force component against membranes 39.

FIG. 9 shows another manner of using hand tool 1 which is generally reversing or inverting the hand tool from that shown in FIG. 8. When used in the position of FIG. 8, the user's thumb is near the free or outer end 37 of handle 3 and when used in the position of FIG. 9 is located adjacent the bracket attachment end. Again, when used in this alternate manner, it still enables the natural wrist position to be achieved wherein the wrist is in alignment with the hand and forearm of the user again to reduce the fatigue and stress on the wrist tendons and surrounding sheathes. The term “natural wrist position” is defined as the position the wrist and hand assume when at rest. This position is characterized by a straight unbroken wrist; the hand rotated to a relaxed 30 degree position; the fingers curled and at rest; and the thumb straight and relaxed. When a person lays the outer part of the forearm on a hard surface and lets it rotate inwardly naturally keeping the wrist straight, it will assume the natural wrist position.

Whether using the roller in the position of FIG. 8 or 9, the installer will find a neutral balance position in which position the arm and especially the wrist will assume the desired natural position without the wrist bending which achieves the desired objective of the hand tool design and construction of the present invention.

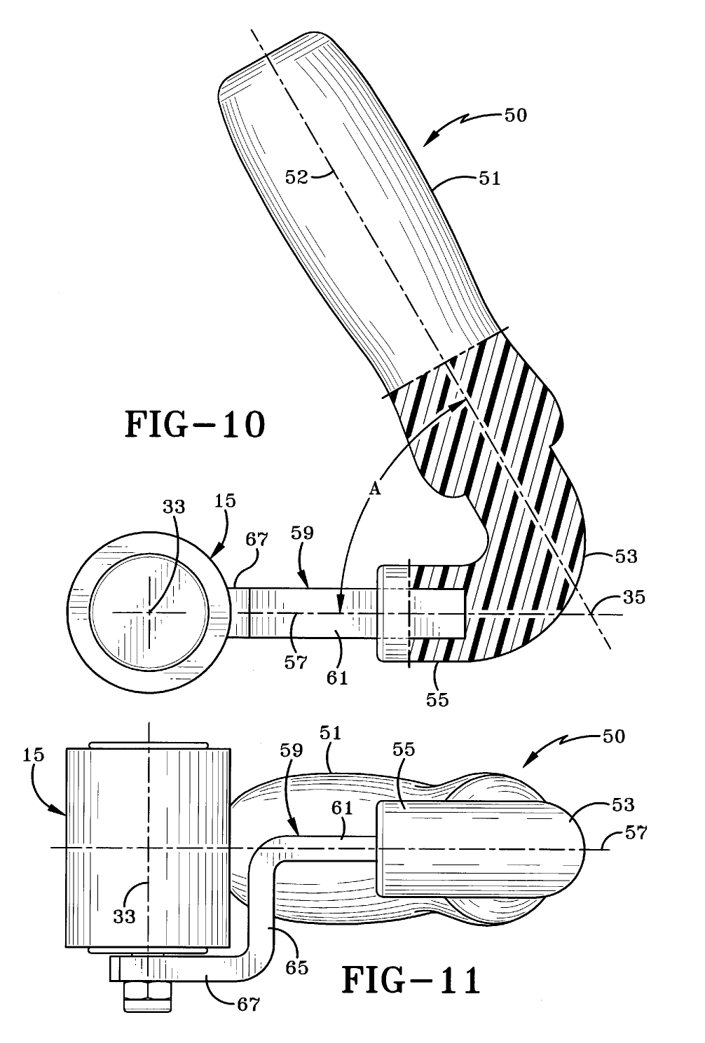

A modified form of the hand tool of the present invention is indicated generally at 50, and is shown in FIGS. 10 and 11. Modified hand tool 50 is formed as a one-piece molded thermoplastic member having a main linearly extending handle body 51 and a rounded corner 53 which merges into a secondary linearly extending section 55 which extends along an axis 57. Axis 57 forms the desired angle A as discussed above, with respect to the linear axis 52 of main handle body 51. The roller mounting bracket 59 is Z-shaped having a first linear section or leg 61 which is embedded within linear section 55. Section 61 merges into a right angle forming section or cross leg 65 which merges into another linear section or leg 67 to which the roller 15 is attached as discussed previously with respect to hand tool 1. Again, mounting bracket 59 extends generally linearly from the linear end section 55 of handle 50 and connects to roller 15 with bracket legs 61 and 67 being offset from and parallel to each other by right angle connecting cross leg 65.

The manner of operation of modified hand tool 50 is the same as that described above with respect to hand tool 1, and merely provides another handle construction in combination with the roller mounting bracket for achieving the desired angle A between the linear axes of main handle body 51 and the linear axis 57 of roller mounting bracket 59.

Thus, improved hand tool 1 and modified embodiment 50 provides a tool which greatly facilitates the installation of forming a seam of overlapping roofing membranes while reducing the fatigue on the installer by permitting the hand, wrist, and forearm to be in a generally straight line wherein the wrist assumes a natural wrist position. These features and advantages are obtained by the hand tool of the present invention which provides a desired included angle of between 50 degrees and 70 degrees between a linear axis of the handle and a linear axis of the roller mounting bracket, which axes form a generally isosceles triangle with an imaginary line extending from the axis of rotation of the roller to the midpoint of the handle. Furthermore, the handle can be formed as a linear member with the desired angle being provided by the roller mounting bracket or by providing the desired angle in a one-piece molded plastic member. Other modifications and configurations to the handle and/or roller mounting bracket can be utilized to achieve the same results.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A hand tool for rolling a roofing membrane comprising:
a handle having front and back ends and a first axis extending therebetween;
a roller mounting bracket extending from the front end of the handle and extending along a second axis;
a shaft attached to a distal end of the mounting bracket;
a roller rotatably mounted on the shaft; and
wherein the first and second axes form an included angle generally in the range of 50 degrees to 70 degrees.

2. The hand roller defined in claim 2 wherein the first and second axes form a preferred angle of approximately 60 degrees.

3. The hand roller defined in claim 1 wherein the roller includes an axis of rotation;
and wherein the second axis is generally perpendicular to said axis of rotation of the roller.

4. The hand roller defined in claim 1 wherein the handle has a length generally in the range of 4½ inches to 5½ inches.

5. The hand roller defined in claim 4 wherein the preferred length of the handle is approximately 5 inches.

6. The hand roller defined in claim 1 wherein the roller has an axis of rotation extending along the shaft and the distance from said axis of rotation of the roller to a junction with the first axis along the axis of the roller mounting bracket is in the range of 3½ inches and 4½ inches.

7. The hand roller defined in claim 6 wherein the preferred distance from the axis of rotation to the junction with the first axis along the axis of the roller mounting bracket is generally 4 7/16 inches.

8. The hand roller defined in claim 1 wherein the roller mounting bracket includes a first straight linear leg extending substantially along the second axis and terminating in a curved section which is attached to the front end of the handle.

9. The hand roller defined in claim 8 wherein the roller mounting bracket further includes a second leg offset from the first leg by a cross leg; and in which said second leg is attached to the roller shaft.

10. The hand roller defined in claim 8 wherein the curved section terminates in a second straight section which is embedded in the handle to attach the roller mounting bracket to the handle.

11. The hand roller defined in claim 1 wherein the handle is a one-piece member having a linear section along which the first axis extends and a curved end section which is attached to the roller mounting bracket; and wherein the curved end section terminates in a linear section along which the second axis extends to form the included angle between the first and second axes.

12. The hand roller defined in claim 11 wherein the one-piece member is a molded thermoplastic.

13. The hand roller defined in claim 11 wherein a Z-shaped metal bracket extends between the linear section of the curved end section of the one-piece member and the roller shaft.

14. A hand tool comprising:
a handle having front and back ends and a first axis extending therebetween;
a roller mounting bracket extending from the front end of the handle and extending along a second axis;
a shaft attached to a distal end of the mounting bracket;
a roller rotatably mounted on the shaft, said shaft providing an axis of rotation of the roller; and
wherein the first axis and second axis form an isosceles triangle with an imaginary line extending from the axis of rotation of the roller and a midpoint of the handle.

15. The hand tool defined in claim 14 wherein the first and second axes form a preferred included angle of approximately 60 degrees.

16. The hand tool defined in claim 14 wherein the handle is generally linear and has a length in the range of 4½ inches to 5½ inches.

17. The hand tool defined in claim 14 wherein the roller mounting bracket includes a first linear section extending substantially along the second axis and a curved section which is attached to the front end of the handle.

18. The hand tool defined in claim 17 wherein the roller mounting bracket further includes a second linear section offset from the first linear section and is attached to one end of the shaft.

19. A method of joining overlapping sheets of sealable material comprising the steps of:
a) providing a hand-held tool having a handle, a roller mounting bracket attached to and extending from the handle and a roller rotatably mounted on a distal end of the mounting bracket for moving along at least one of the sheets, said handle extending substantially along a first axis and said roller mounting bracket extending substantially along a second axis with said first and second axes forming an included angle of between 50 degrees and 70 degrees; and
b) moving the roller along the at least one of the sheets of sealable material by manually applying either a pushing or pulling force on the handle while generally maintaining an angle of between 20 degrees and 40 degrees between the said one sheet and the second axis of the roller mounting bracket enabling the forearm and wrist of a user to be in linear alignment.

20. The method defined in claim 19 including the step of providing the roller mounting bracket as a one-piece metal member having at least a pair of linear sections lying in a common plane and an intervening curved corner forming the included angle between said first and second axes.
